(19) United States
(12) Patent Application Publication
(10) Pub. No.: US 2011/0093649 A1
(43) Pub. Date: Apr. 21, 2011

(54) METHOD FOR MANAGING A PLURALITY OF BLOCKS OF A FLASH MEMORY, AND ASSOCIATED MEMORY DEVICE AND CONTROLLER THEREOF

(76) Inventor: Chun-Kun Lee, Hsinchu County (TW)

(21) Appl. No.: 12/652,745

(22) Filed: Jan. 6, 2010

(30) Foreign Application Priority Data
Oct. 16, 2009 (TW) 098135100

(51) Int. Cl. G06F 12/02

(52) U.S. Cl. 711/103; 711/E12.008

(57) ABSTRACT

A method for managing a plurality of blocks of a Flash memory includes: providing at least one logical-to-physical block linking table within the Flash memory, wherein regarding a plurality of logical block addresses, the logical-to-physical block linking table initially stores at least one initial value falling outside a range of respective physical block addresses of the Flash memory to prevent the logical block addresses from being initially linked to the physical block addresses; and when it is required to write data belonging to a logical block address into the Flash memory, writing a physical block address of the physical block addresses into an updated version of the logical-to-physical block linking table in order to link the logical block address to the physical block address. An associated memory device and a controller thereof are also provided, where the controller includes: a ROM; and a microprocessor.

### BACKGROUND OF THE INVENTION

1. Field of the Invention

The present invention relates to access to a Flash memory, and more particularly, to a method for managing a plurality of blocks of a Flash memory, and to an associated memory device and a controller thereof.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. Therefore, some suggestions are provided in response to these problems in the related art. Please note that a portion of the suggestions provided in the related art may cause some side effects. For example, the endurance of the MLC Flash memories may become lower, the performance may become worse, the reading/writing speed may decrease, the probability of the occurrence of reading/writing errors may increase, and some problems may occur when implementing certain kinds of portable memory devices, such as memory cards complying with the SD standards. Thus, a novel method is required for enhancing the control of data access to Flash memories, in order to enhance the overall performance of portable memory devices.

### SUMMARY OF THE INVENTION

It is therefore an objective of the claimed invention to provide a method for managing a plurality of blocks of a Flash memory, and to provide an associated memory device and a controller thereof, in order to achieve the best overall performance of portable memory devices.

According to a preferred embodiment of the claimed invention, a method for managing a plurality of blocks of a Flash memory comprises: providing at least one logical-to-physical block linking table within the Flash memory, wherein regarding a plurality of logical block addresses, the logical-to-physical block linking table initially stores at least one initial value falling outside a range of respective physical block addresses of the Flash memory to prevent the logical block addresses from being initially linked to the physical block addresses; and when it is required to write data belonging to a logical block address into the Flash memory, writing a physical block address of the physical block addresses into an updated version of the logical-to-physical block linking table in order to link the logical block address to the physical block address.

While the method mentioned above is disclosed, an associated memory device is further provided. The memory device comprises: a Flash memory comprising a plurality of blocks and storing at least one logical-to-physical block linking table, wherein regarding a plurality of logical block addresses, the logical-to-physical block linking table initially stores at least one initial value falling outside a range of respective physical block addresses of the Flash memory to prevent the logical block addresses from being initially linked to the physical block addresses; and a controller arranged to access the Flash memory and manage the plurality of blocks. In addition, when it is required to write data belonging to a logical block address into the Flash memory, the controller writes a physical block address of the physical block addresses into an updated version of the logical-to-physical block linking table in order to link the logical block address to the physical block address.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device according to a first embodiment of the present invention.

FIG. 2 is a flowchart of a method for managing a plurality of blocks of a Flash memory according to an embodiment of the present invention.

FIG. 3 illustrates a logical-to-physical block linking table involved with the method shown in FIG. 2 according to an embodiment of the present invention.

FIG. 4 illustrates an updated version of the logical-to-physical block linking table shown in FIG. 3 after a physical block address has been written therein according to an embodiment of the present invention.

### DETAILED DESCRIPTION

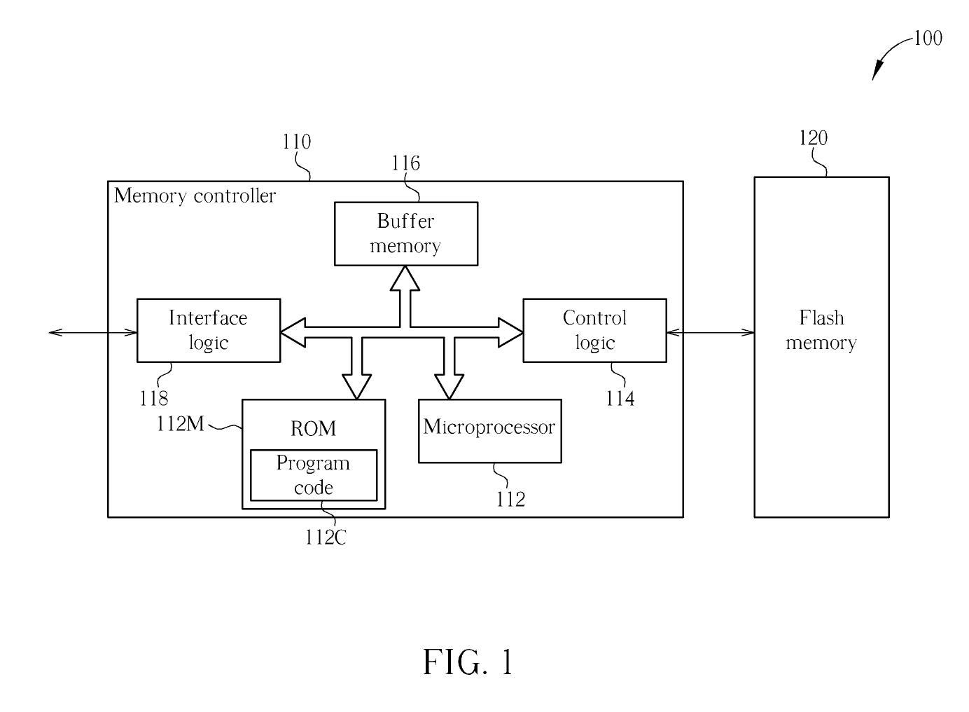

Please refer to FIG. 1, which illustrates a diagram of a memory device 100 according to a first embodiment of the present invention. In particular, the memory device 100 of this embodiment is a portable memory device, such as a memory card complying with SD/MMC, CF, MS, or XD standards. The memory device 100 comprises a Flash memory 120, and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control the access to the Flash memory 120. Please note that, according to different variations of this embodiment, the program code 112C can be stored in the buffer memory 116 or any other memory. Here, the Flash memory 120 may comprise at least one Flash memory chip (i.e. one or more Flash memory chips).

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller mentioned above performs data writing operations on the Flash memory 120 by writing/programming in units of pages.

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device such as a personal computer (PC) owned by the user.

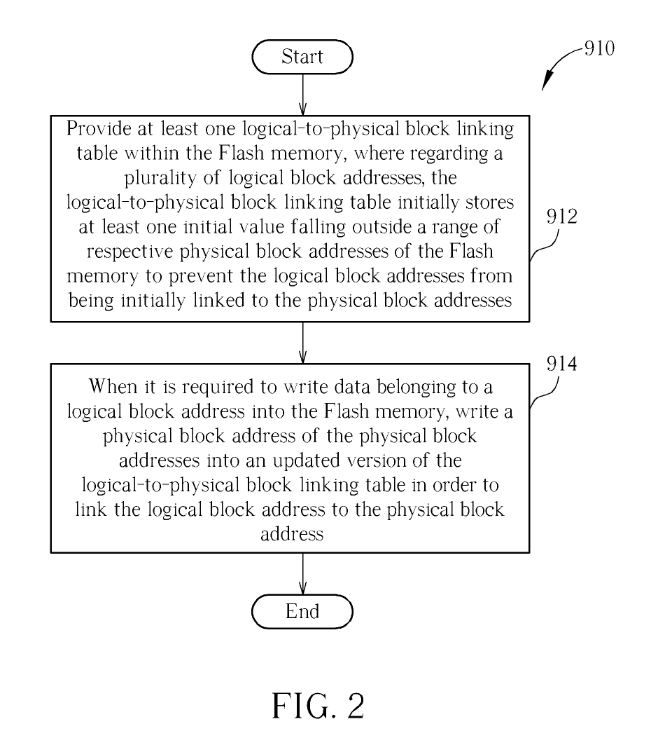

According to this embodiment, in addition to accessing the Flash memory 120, the controller is capable of properly managing the plurality of blocks. More specifically, the Flash memory 120 stores at least one logical-to-physical block linking table, where regarding a plurality of logical block addresses, the logical-to-physical block linking table initially stores at least one initial value falling outside a range of respective physical block addresses of the Flash memory 120 to prevent the logical block addresses from being initially linked to the physical block addresses. When it is required to write data belonging to a logical block address into the Flash memory 120, the controller can write a physical block address of the physical block addresses into an updated version of the logical-to-physical block linking table in order to link the logical block address to the physical block address. Related details are further described as follows by referring to FIG. 2.

FIG. 2 is a flowchart of a method 910 for managing a plurality of blocks of a Flash memory according to an embodiment of the present invention. The method can be applied to the memory device 100 shown in FIG. 1, and more particularly, to the controller mentioned above (e.g. the memory controller 110 that executes the program code 112C by utilizing the microprocessor 112). In addition, the method can be implemented by utilizing the memory device 100 shown in FIG. 1, and more particularly, by utilizing the controller mentioned above. The method 910 is described as follows.

In Step 912, provide at least one logical-to-physical block linking table within the Flash memory 120, where regarding a plurality of logical block addresses, the logical-to-physical block linking table initially stores at least one initial value falling outside a range of respective physical block addresses of the Flash memory 120 to prevent the logical block addresses from being initially linked to the physical block addresses. In this embodiment, the aforementioned at least one initial value comprises a single initial value. That is, regarding the plurality of logical block addresses, the logical-to-physical block linking table initially stores the same initial value in the respective fields thereof. For example, in a situation where the value 0xFFFF falls outside the range of the respective physical block addresses of the Flash memory 120, the initial value mentioned above can be the value 0xFFFF. This is for illustrative purposes only, and is not meant to be a limitation of the present invention. According to a variation of this embodiment, the aforementioned at least one initial value may comprise a plurality of initial values. More particularly, in this variation, regarding the plurality of logical block addresses, the logical-to-physical block linking table may initially respectively store initial values that fall outside the range of the respective physical block addresses and are not all the same in the respective fields thereof, in order to prevent the logical block addresses from being initially linked to the physical block addresses.

In Step 914, when it is required to write data belonging to a logical block address into the Flash memory 120, the aforementioned controller (e.g. the memory controller 110 that executes the program code 112C by utilizing the microprocessor 112) writes a physical block address of the physical block addresses into an updated version of the logical-to-physical block linking table in order to link the logical block address to the physical block address. For example, the controller can first write the physical block address into the updated version of the logical-to-physical block linking table within the buffer memory 116, and when it is required, the controller can restore the updated version into the Flash memory 120. In another example, the controller can directly write the physical block address into the updated version of the logical-to-physical block linking table within the Flash memory 120.

In this embodiment, within the plurality of blocks, all of the blocks whose physical block addresses are not written into the updated version of the logical-to-physical block linking table are spare blocks. Thus, before Step 914 is executed, all of the blocks within the Flash memory 120 can be spare blocks. Please note that the memory device 100 owns the maximal possible number of spare blocks for being arbitrarily utilized at any time. Therefore, by utilizing a large number of spare blocks, the present invention can provide the memory device 100 with extremely high flexibility, in order to achieve the best overall performance of portable memory devices.

In addition, within the plurality of blocks, all of the blocks whose physical block addresses are written into the updated version of the logical-to-physical block linking table are data blocks. Please note that Step 914 can be executed multiple times when needed. As a result, while the operations of Step 914 are performed, the controller utilizes a portion of the spare blocks as new data blocks. For example, the physical block address mentioned in Step 914 may represent a data block.

According to this embodiment, the controller can first classify a new data block (e.g. the data block represented by the physical block address mentioned in Step 914) as a child block, in order to write data of at least one portion of logical pages belonging to the logical block address into corresponding physical pages within the data block. In this situation, during or after certain data accessing operation(s), the controller can determine whether data of the data block is not continuous enough according to at least one criterion. When it is determined that the data of the data block is not continuous enough, the controller can classify the data block as a file allocation table (FAT) block, in order to write data of at least one logical page into the data block and to write a corresponding page linking table into the Flash memory 120. As a result of utilizing the page linking table when accessing the FAT block, regarding random data access to the data block, the controller can provide the memory device 100 with extremely high flexibility by dynamically switching from operations of the child block to operations of the FAT block.

In this embodiment, the aforementioned at least one criterion comprises a first criterion, a second criterion, and a third criterion. It is not necessary for these criteria to be involved with a specific checking order thereof. The first criterion is described as follows. When the difference between the page address of a page to be written into the data block and the page address of a page written into the data block at the last time reaches a predetermined value, the controller determines that the data of the data block is not continuous enough. According to different implementation choices of this embodiment, the difference can be a difference between logical page addresses, or a difference between physical page addresses. In addition, the predetermined value represents a product obtained from multiplying the total page count of a block by a certain proportion parameter. In particular, the proportion parameter can be obtained in advance through trial experiments or theoretical calculations. For example, in a situation where the proportion parameter is equal to ¼, the predetermined value represents a quarter of the total page count.

The second criterion is described as follows. When a logical page to be first written into the data block is not at the beginning of the logical block to which the logical page belongs, the controller determines that the data of the data block is not continuous enough. That is, as long as the logical page to be first written into the data block is not the first logical page of this logical block, the second criterion is satisfied, and therefore, the controller determines that the data of the data block is not continuous enough.

The third criterion is described as follows. When the page address of a page to be written into the data block is equivalent to the page address of a page previously written into the data block, the controller determines that the data of the data block is not continuous enough. That is, as long as the controller detects that the same page is to be repeatedly written within the data block, the third criterion is satisfied, and therefore, the controller determines that the data of the data block is not continuous enough.

According to this embodiment, as the controller can re-classify the data block, not only can child blocks become FAT blocks, but also FAT blocks can become child blocks. For example, when the ratio of the page count of continuous logical pages to be written into the data block to the total page count of a block reaches a predetermined proportion, and the beginning of the continuous logical pages is the beginning of the logical block to which the continuous logical pages belong, and, within the data block, all of the portion of pages to be written are blank pages, the controller classifies the data block as a child block, in order to write data of the continuous logical pages into corresponding physical pages within the data block.

In addition, the number of spare blocks may decrease as the number of data blocks increases. In this situation, the controller can merge the valid pages of multiple data blocks into a new data block, and erase these old data blocks (whose valid pages are utilized in this merging operation) in order to make these old data blocks become new spare blocks. For example, the controller can merge the valid pages of a plurality of FAT blocks into a new data block, and erase the plurality of FAT blocks in order to make theses FAT blocks become new spare blocks. Therefore, the controller can maintain a fairly sufficient amount of spare blocks, in order to achieve the best overall performance of portable memory devices.

As mentioned, the controller can first classify a new data block (e.g. the data block represented by the physical block address mentioned in Step 914) as a child block. In particular, the controller can classify each new data block as a child block according to certain predetermined value(s). This is for illustrative purposes only, and is not meant to be a limitation of the present invention. According to a variation of this embodiment, the controller can determine whether to first classify a new data block (e.g. the data block represented by the physical block address mentioned in Step 914) as a FAT block according to at least one criterion. More particularly, in this variation, the controller can determine whether data of the data block is not continuous enough according to at least one criterion (e.g. the second criterion mentioned above). When it is determined that the data of the data block is not continuous enough, the controller classifies the data block as a FAT block, in order to write data of at least one logical page into the data block and to write a corresponding page linking table into the Flash memory 120. Similarly, as the controller can re-classify the data block, not only can FAT blocks become child blocks, but also child blocks can become FAT blocks. Similar descriptions for this variation are not repeated in detail here.

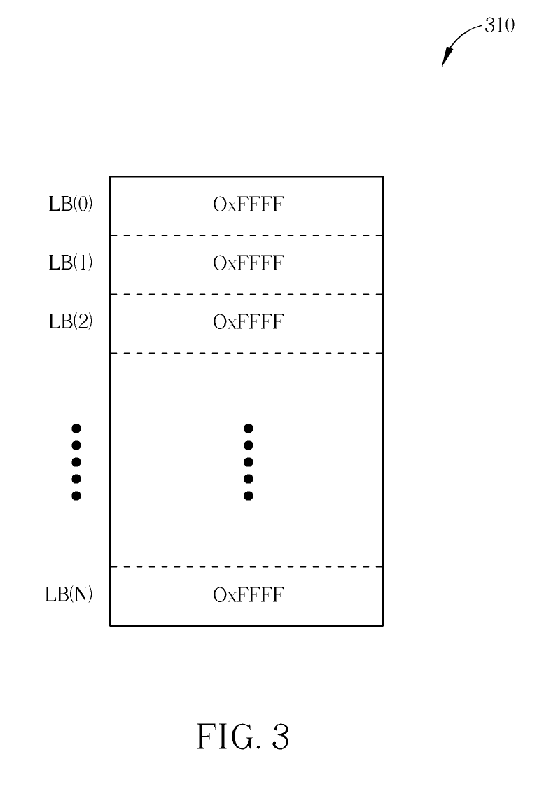

FIG. 3 illustrates a logical-to-physical block linking table 310 involved with the method shown in FIG. 2 according to an embodiment of the present invention. Regarding the plurality of logical block addresses such as the logical block addresses LB(0), LB(1), LB(2), . . . , and LB(N) shown in FIG. 3, the controller mentioned above (e.g. the memory controller 110 that executes the program code 112C by utilizing the microprocessor 112) can respectively write the aforementioned at least one initial value into the respective fields of the logical-to-physical block linking table 310. This operation can be simply referred to as the initial value writing operation. In this embodiment, in a situation where the value 0xFFFF falls outside the range of the respective physical block addresses of the Flash memory 120, the initial value mentioned above can be the value 0xFFFF.

In practice, the controller can perform the initial value writing operation under control of a setting device. For example, the setting device can be a specific host device executing a setting program, and the setting program has related control functions of the initial value writing operation, where the specific host device can be a PC set up by the manufacturer of the memory device 100. In particular, the initial value writing operation can be performed when assembling the memory device 100 is completed. This is for illustrative purposes only, and is not meant to be a limitation of the present invention. According to a variation of this embodiment, the manufacturer of the memory device 100 can provide the user with a recovery program, and the recovery program has the related control functions of the initial value writing operation, where the user can utilize the host device (e.g. the PC of the user) to execute the recovery program. As a result, under control of the host device executing the recovery program, the controller can perform the initial value writing operation, in order to prevent the logical block addresses LB(0), LB(1), LB(2), . . . , and LB(N) from being initially linked to the physical block addresses after the recovery program is executed.

According to another variation of this embodiment, the initial value writing operation can be performed under control of a reset procedure of the memory device 100. More particularly, in this variation, the user can trigger the reset procedure by utilizing a reset switch (not shown) of the memory device 100. As a result of triggering the reset procedure, the controller performs the initial value writing operation, in order to prevent the logical block addresses LB(0), LB(1), LB(2), . . . , and LB(N) from being initially linked to the physical block addresses after the reset procedure.

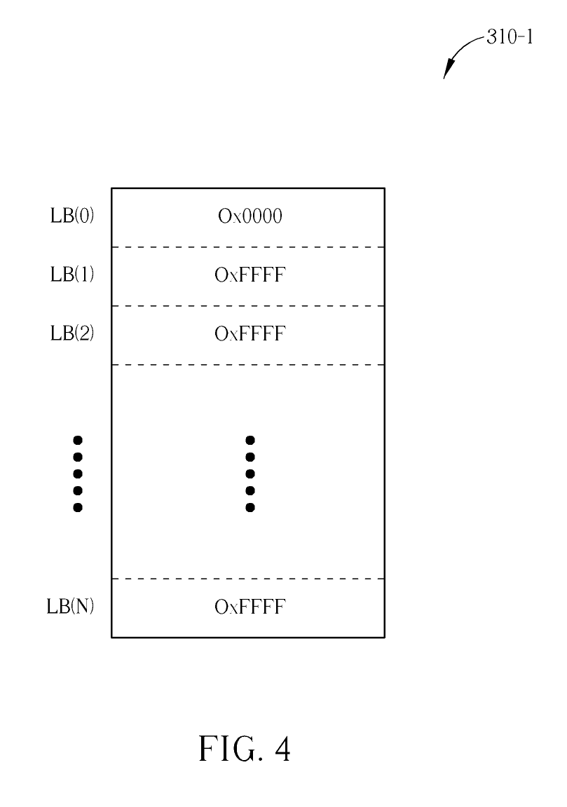

FIG. 4 illustrates an updated version 310-1 of the logical-to-physical block linking table 310 shown in FIG. 3 after a physical block address has been written therein according to an embodiment of the present invention. In practice, the updated version 310-1 can be temporarily stored in the buffer memory 116, and when it is required, the controller can restore the updated version 310-1 into the Flash memory 120. In this embodiment, in a situation where Step 914 is executed for the first time, the logical block address and the physical block address are respectively LB(0) and 0x0000, which means the controller links the logical block address LB(0) to the physical block address 0x0000. Similar descriptions for this embodiment are not repeated in detail here.

It is an advantage of the present invention that the memory device can have a fairly sufficient amount of spare blocks at any time, rather than generating new spare blocks when the number of spare blocks is not enough as suggested in the related art. As a result, the present invention can achieve the best overall performance of portable memory devices. In addition, in a situation where the data blocks comprise at least one child block or at least one FAT block, it is not necessary for the data blocks of any of the above-disclosed embodiments/variations to comprise corresponding mother block(s) as in the related art. That is, no matter whether the data blocks of any of the above-disclosed embodiments/variations comprise corresponding mother block(s) or not, the implementation of the present invention will not be hindered. Additionally, it is typically required for the related art to copy data from a mother block to another block when performing writing or merging operations. In contrast to the related art, the present invention can omit many copying operation that are considered unnecessary when performing writing or merging operations. Therefore, the present invention can achieve the best overall performance of portable memory devices.

Those skilled in the art will readily observe that numerous modifications and alterations of the device and method may be made while retaining the teachings of the invention.

What is claimed is:

1. A method for managing a plurality of blocks of a Flash memory, the method comprising:
providing at least one logical-to-physical block linking table within the Flash memory, wherein regarding a plurality of logical block addresses, the logical-to-physical block linking table initially stores at least one initial value falling outside a range of respective physical block addresses of the Flash memory to prevent the logical block addresses from being initially linked to the physical block addresses; and
when it is required to write data belonging to a logical block address into the Flash memory, writing a physical block address of the physical block addresses into an updated version of the logical-to-physical block linking table in order to link the logical block address to the physical block address.

2. The method of claim 1, wherein within the plurality of blocks, all of the blocks whose physical block addresses are not written into the updated version of the logical-to-physical block linking table are spare blocks; and within the plurality of blocks, all of the blocks whose physical block addresses are written into the updated version of the logical-to-physical block linking table are data blocks.

3. The method of claim 2, wherein the physical block address represents a data block; and the method further comprises:
classifying the data block as a child block, in order to write data of at least one portion of logical pages belonging to the logical block address into corresponding physical pages within the data block.

4. The method of claim 3, further comprising:
determining whether data of the data block is not continuous enough according to at least one criterion; and
when it is determined that the data of the data block is not continuous enough, classifying the data block as a file allocation table (FAT) block, in order to write data of at least one logical page into the data block and to write a corresponding page linking table into the Flash memory.

5. The method of claim 4, wherein the step of determining whether the data of the data block is not continuous enough according to the at least one criterion further comprises:
when a difference between a page address of a page to be written into the data block and a page address of a page written into the data block at a last time reaches a predetermined value, determining that the data of the data block is not continuous enough.

6. The method of claim 4, wherein the step of determining whether the data of the data block is not continuous enough according to the at least one criterion further comprises:
when a logical page to be first written into the data block is not at a beginning of a logical block to which the logical page belongs, determining that the data of the data block is not continuous enough.

7. The method of claim 4, wherein the step of determining whether the data of the data block is not continuous enough according to the at least one criterion further comprises:
when a page address of a page to be written into the data block is equivalent to a page address of a page previously written into the data block, determining that the data of the data block is not continuous enough.

8. The method of claim 2, wherein the physical block address represents a data block; and the method further comprises:
determining whether data of the data block is not continuous enough according to at least one criterion; and
when it is determined that the data of the data block is not continuous enough, classifying the data block as a file allocation table (FAT) block, in order to write data of at least one logical page into the data block and to write a corresponding page linking table into the Flash memory.

9. The method of claim 8, further comprising:
when a ratio of a page count of continuous logical pages to be written into the data block to a total page count of a block reaches a predetermined proportion, and a beginning of the continuous logical pages is a beginning of a logical block to which the continuous logical pages belong, and, within the data block, all of a portion of pages to be written are blank pages, classifying the data block as a child block, in order to write data of the continuous logical pages into corresponding physical pages within the data block.

10. The method of claim 1, further comprising:
regarding the logical block addresses, respectively writing the at least one initial value into respective fields of the logical-to-physical block linking table.

11. A memory device, comprising:
a Flash memory comprising a plurality of blocks and storing at least one logical-to-physical block linking table, wherein regarding a plurality of logical block addresses, the logical-to-physical block linking table initially stores at least one initial value falling outside a range of respective physical block addresses of the Flash memory to prevent the logical block addresses from being initially linked to the physical block addresses; and a controller arranged to access the Flash memory and manage the plurality of blocks; and
a controller arranged to access the Flash memory and manage the plurality of blocks, wherein when it is required to write data belonging to a logical block address into the Flash memory, the controller writes a physical block address of the physical block addresses into an updated version of the logical-to-physical block linking table in order to link the logical block address to the physical block address.

12. The memory device of claim 11, wherein within the plurality of blocks, all of the blocks whose physical block addresses are not written into the updated version of the logical-to-physical block linking table are spare blocks; and within the plurality of blocks, all of the blocks whose physical block addresses are written into the updated version of the logical-to-physical block linking table are data blocks.

13. The memory device of claim 12, wherein the physical block address represents a data block; and the controller classifies the data block as a child block, in order to write data of at least one portion of logical pages belonging to the logical block address into corresponding physical pages within the data block.

14. The memory device of claim 13, wherein the controller determines whether data of the data block is not continuous enough according to at least one criterion; and when it is determined that the data of the data block is not continuous enough, the controller classifies the data block as a file allocation table (FAT) block, in order to write data of at least one logical page into the data block and to write a corresponding page linking table into the Flash memory.

15. The memory device of claim 14, wherein when a difference between a page address of a page to be written into the data block and a page address of a page written into the data block at a last time reaches a predetermined value, the controller determines that the data of the data block is not continuous enough.

16. The memory device of claim 14, wherein when a logical page to be first written into the data block is not at a beginning of a logical block to which the logical page belongs, the controller determines that the data of the data block is not continuous enough.

17. The memory device of claim 14, wherein when a page address of a page to be written into the data block is equivalent to a page address of a page previously written into the data block, the controller determines that the data of the data block is not continuous enough.

18. The memory device of claim 12, wherein the physical block address represents a data block; the controller determines whether data of the data block is not continuous enough according to at least one criterion; and when it is determined that the data of the data block is not continuous enough, the controller classifies the data block as a file allocation table (FAT) block, in order to write data of at least one logical page into the data block and to write a corresponding page linking table into the Flash memory.

19. The memory device of claim 18, wherein when a ratio of a page count of continuous logical pages to be written into the data block to a total page count of a block reaches a predetermined proportion, and a beginning of the continuous logical pages is a beginning of a logical block to which the continuous logical pages belong, and, within the data block, all of a portion of pages to be written are blank pages, the controller classifies the data block as a child block, in order to write data of the continuous logical pages into corresponding physical pages within the data block.

20. The memory device of claim 11, wherein regarding the logical block addresses, the controller respectively writes the at least one initial value into respective fields of the logical-to-physical block linking table.
